(19) United States
(12) Patent Application Publication
(10) Pub. No.: US 2010/0058756 A1
(43) Pub. Date: Mar. 11, 2010

(54) MOVEMENT DEVICE

(75) Inventor: Heng-Yung SU, Sinjhuang City (TW)

Correspondence Address: Workman Nydegger;1000 Eagle Gate Tower, 60 East South Temple, Salt Lake City, UT, 84111, US

(73) Assignee: MICRO-STAR INTERNATIONAL CO., LTD., Jung-He City (TW)

(21) Appl. No.: 12/260,244

(22) Filed: Oct. 29, 2008

(30) Foreign Application Priority Data
Sep. 10, 2008 (TW) 097134739

(51) Int. Cl. F03G 7/06

(52) U.S. Cl. 60/527

(57) ABSTRACT

A movement device suitable for performing a mechanical movement upon being powered by a power source includes a control element, a temperature chip, and two memory deforming elements. The temperature chip has a first surface and a second surface. The two memory deforming elements have a connection part and a movement part respectively. The temperature chip is electrically connected to the control element. The connection parts of the two memory deforming element are respectively disposed on the first surface and the second surface. The control element controls a direction of a current from the power source when passing through the temperature chip, and the first surface and the second surface respectively generate an exothermic effect or an endothermic effect according to a direction of the current from the power source, so the two memory deforming elements are heated or cooled, thus the movement part produces a movement through temperature control.

### CROSS-REFERENCE TO RELATED APPLICATIONS

This non-provisional application claims priority under 35 U.S.C. §119(a) on Patent Application No(s). 097134739 filed in Taiwan, R.O.C. on Sep. 10, 2008 the entire contents of which are hereby incorporated by reference.

### BACKGROUND OF THE INVENTION

1. Field of the Invention

The present invention relates to a movement device, and more particularly to a movement device, in which a movement state is controlled through a current direction.

2. Related Art

With the continuous development of technologies, in many works with high risks, former laborers have been gradually replaced by an automatic device such as a robot arm. As the technologies about the robot arm and other automatic devices have been developed, more and more people are involved in the research and development of small-scale automatic devices such as robot or robot toy. Therefore, in the current robot technologies, the motions that seemed to be performed by a real person can be performed by a robot. Recently, all the robots are configured with a chip and a memory device respectively, and the memory device may be a variable sequence control device or a fixed sequence control device. In this manner, the robot may transmit a signal through the memory device, such that a manipulator of the robot executes various motions such as moving, rotation, extension, and the like.

In a movement device for a conventional robot, for example, a robot arm, the chip controls a high-precise servo motor to timely drive a gear or other linking mechanisms to perform movements in different occasions, so as to perform the motion set by the user. However, the operating manner of the conventional movement device that the servo motor drives the gear to further drive the other linking mechanisms to perform movements belongs to a mechanical operation, and the servo motor is rather expensive. In order to match with the high shaft rotation speed of the servo motor, a precise reduction gear is required, so as to control motions of the movement device accurately. After being used for a long time, it needs to add lubricating oil to an axis center or to tighten the screws, so as to prevent the movement device from producing noises during the operation, thereby enhancing the operation smoothness.

### SUMMARY OF THE INVENTION

In the conventional movement device, the servo motor drives the gear to further drive other linking mechanisms to perform movements, so that the expensive high-precise servo motor is required to be used together with the reduction gear, so as to achieve the objective of accurate control. After being used for a long time, it is necessary to timely check whether a linking relation between the motor and the gear is loosened or not, or it is necessary to add the lubricating oil to the axis center, so as to enhance the operation smoothness and to reduce the noises produced during the operation.

The present invention provides a movement device, which is suitable for performing a mechanical movement upon being powered by a power source. The movement device includes a control element, a temperature chip, a first memory deforming element, and a second memory deforming element. The temperature chip has a first surface and a second surface. The first memory deforming element and the second memory deforming have a connection part and a movement part respectively, and each movement part has a deformed state and an undeformed state. The control element is electrically connected to the power source, and the temperature chip is electrically connected to the control element. The connection part of the first memory deforming element and the connection part of the second memory deforming element are respectively disposed on the first surface and the second surface. The control element controls a current direction of the power source when passing through the temperature chip, and the first surface and the second surface respectively generate an exothermic effect or an endothermic effect according to the current direction of the power source, so the first memory deforming element and the second memory deforming element are heated or cooled, and thus the movement part of the first memory deforming element and the movement part of the second memory deforming element are turned into the deformed state or the undeformed state respectively through temperature control, so as to produce a movement.

The efficacies of the present invention are listed as follows. The control element controls the direction of the current when passing through the temperature chip, and the first surface and the second surface respectively generate the exothermic effect or the endothermic effect, so the first memory deforming element and the second memory deforming element are heated or cooled, and thus the movement part of the first memory deforming element and the movement part of the second memory deforming element are turned into the deformed state or the undeformed state respectively through the temperature control, so as to produce a movement. In this manner, even after a long time usage, the operation smoothness of the movement device can still be guaranteed, and it is ensured that no noise is produced during the operation.

### BRIEF DESCRIPTION OF THE DRAWINGS

The present invention will become more fully understood from the detailed description given herein below for illustration only, and thus is not limitative of the present invention, and wherein:

FIG. 1 is a schematic view of an operation of the present invention;

FIG. 2A is a schematic view of an actuation according to a first embodiment of the present invention;

FIG. 2B is a schematic view of the actuation according to the first embodiment of the present invention;

FIG. 3A is a schematic view of an actuation according to a second embodiment of the present invention;

FIG. 3B is a schematic view of the actuation according to the second embodiment of the present invention;

FIG. 3C is a schematic view of an extension motion according to the second embodiment of the present invention;

FIG. 4A is a schematic view of an actuation according to a third embodiment of the present invention;

FIG. 4B is a schematic view of the actuation according to the third embodiment of the present invention;

FIG. 5A is a schematic view of an actuation according to a fourth embodiment of the present invention;

FIG. 5B is a schematic view of the actuation according to the fourth embodiment of the present invention; and

FIG. 5C is a schematic view of the actuation according to the fourth embodiment of the present invention.

### DETAILED DESCRIPTION OF THE INVENTION

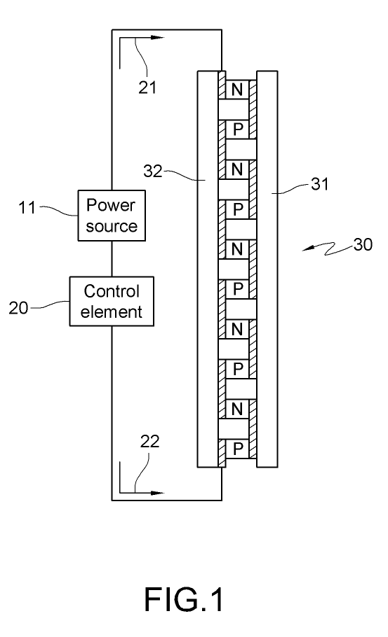

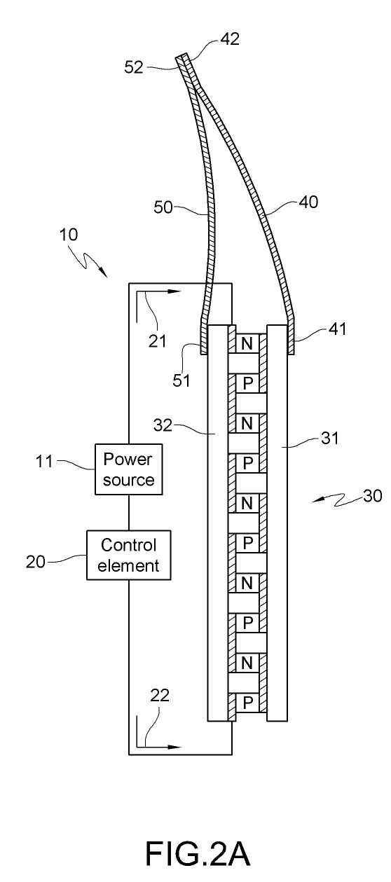

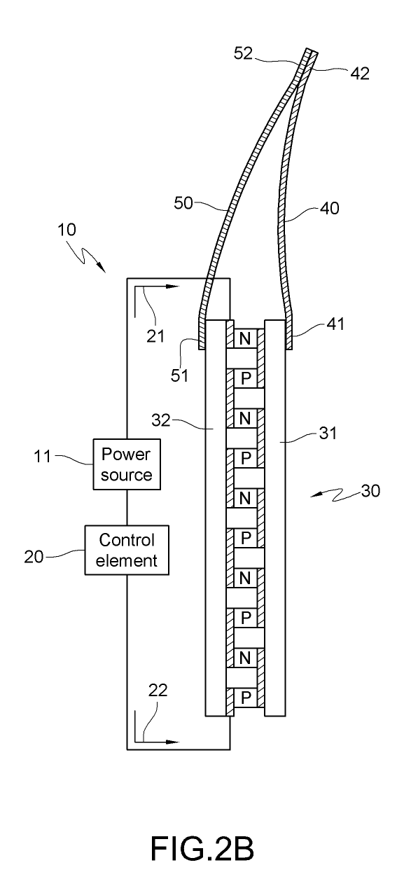

FIGS. 1, 2A, and 2B are schematic views of a first embodiment of the present invention. Referring to FIGS. 1, 2A, and 2B, a movement device 10 of the present invention performs a mechanical movement upon being powered by a power source 11. The movement device 10 includes a control element 20, a temperature chip 30, a first memory deforming element 40, and a second memory deforming element 50.

Referring to FIG. 1, the control element 20 is electrically connected to the power source 11, and the temperature chip 30 is electrically connected to the control element 20. The temperature chip 30 has a first surface 31 and a second surface 32, and the first surface 31 and the second surface 32 are made of a material with plasticity and desirable thermal conductivity. Between the first surface 31 and the second surface 32, a circuit formed by connecting many semiconductor thermocouples is configured. Two ends of the temperature chip 30 are electrically connected to the power source 11 respectively. The power source 11 supplies a direct current (DC). The control element 20 switches a current direction of the power source 11, and controls the current to flow to the temperature chip 30 via a first path 21 or a second path 22. When the current flows to the temperature chip 30 via the first path 21, the current flows through free electrons in an N-type semiconductor, and then enters a P-type semiconductor, and accordingly, a temperature of the second surface 32 falls to produce an exothermic effect, and meanwhile, a temperature of the first surface 31 rises to produce an endothermic effect. When the current flows to the temperature chip 30 via the second path 22, the current flows through free electrons in the P-type semiconductor, and then enters the N-type semiconductor, and the free electrons absorbs the heats, such that the temperature of the first surface 31 falls to produce the exothermic effect, and in contrast, the temperature of the second surface 32 rises to produce the endothermic effect. The intensity of the endothermic effect or the exothermic effect is controlled by the magnitude of the current passing through the temperature chip 30.

Referring to FIGS. 2A and 2B, the first memory deforming element 40 has a connection part 41 and a movement part 42, and the second memory deforming element 50 has a connection part 51 and a movement part 52. The connection part 41 of the first memory deforming element 40 is disposed on the first surface 31, and the connection part 51 of the second memory deforming element 50 is disposed on the second surface 32. The movement part 42 of the first memory deforming element 40 is connected to the movement part 52 of the second memory deforming element 50. The first memory deforming element 40 and the second memory deforming element 50 are formed by a shape memory metal, and the shape memory metal is made of an alloy. When the alloy is firstly bent and set into a certain shape, and then heated to a high temperature phase austenite form of the alloy, the alloy is turned into a deformed state. After the shape memory metal is cooled, it restores its former shape in a martensitic form before being bent and set, that is, an undeformed state. As shown in FIG. 2A, the movement part 42 of the first memory deforming element 40 is in the undeformed state, and the movement part 52 of the second memory deforming element 50 is in the deformed state. As shown in FIG. 2B, the movement part 42 of the first memory deforming element 40 is in the deformed state, and the movement part 52 of the second memory deforming element 50 is in the undeformed state.

When the control element 20 controls the current supplied by the power source 11 to flow to the temperature chip 30 via the first path 21, the first surface 31 generates the endothermic effect, and the second surface 32 generates the exothermic effect, such that the first memory deforming element 40 is cooled and the second memory deforming element 50 is heated. Therefore, the movement part 42 of the first memory deforming element 40 is turned into the undeformed state, and the movement part 52 of the second memory deforming element 50 is turned into the deformed state, as shown in FIG. 2A. On the contrary, when the control element 20 controls the current generated by the power source 11 to flow to the temperature chip 30 via the second path 22, the movement part 42 of the first memory deforming element 40 is turned into the deformed state, and the movement part 52 of the second memory deforming element 50 is turned into the undeformed state, as shown in FIG. 2B. When the current direction is always switched, the movement device 10 performs a left-and-right swing movement repeatedly. The first embodiment of the present invention may be applied to achieve the movement phenomenon, for example, a robot uses a fan, or a robot fish wags its tail.

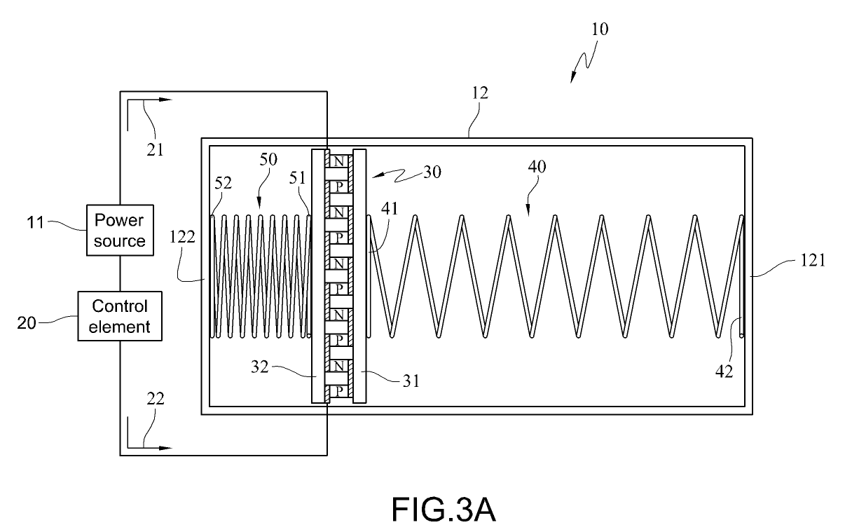

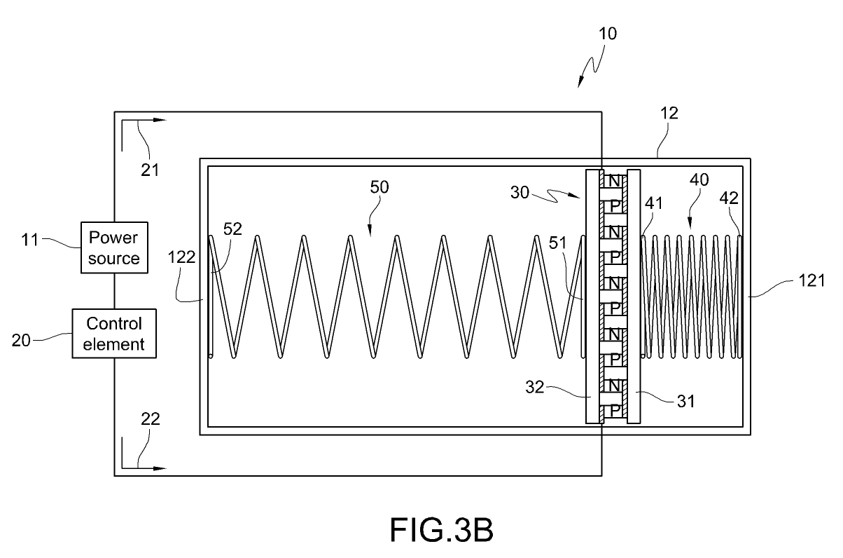

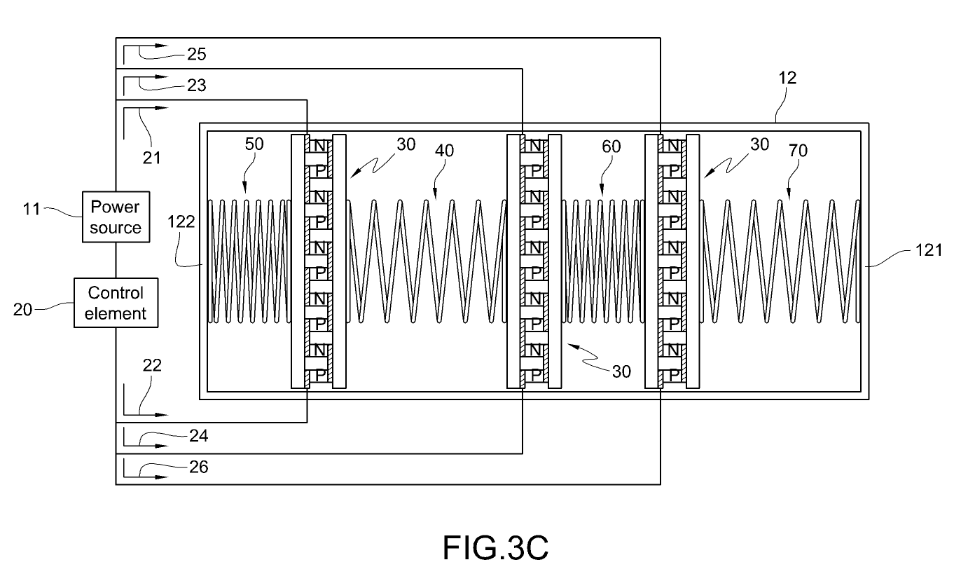

FIGS. 3A and 3B are schematic views of a second embodiment of the present invention. Referring to FIGS. 3A and 3B, a movement device 10 of the present invention performs a mechanical movement upon being powered by a power source 11. The movement device 10 includes a control element 20, a temperature chip 30, a first memory deforming element 40, and a second memory deforming element 50.

The control element 20 is electrically connected to the power source 11, and the temperature chip 30 is electrically connected to the control element 20. The temperature chip 30 has a first surface 31 and a second surface 32, and two ends of the temperature chip 30 are electrically connected to the power source 11 respectively. The power source 11 supplies a DC. The control element 20 switches a current direction of the power source 11, and controls the current to flow to the temperature chip 30 via a first path 21 or a second path 22, such that the first surface 31 and the second surface 32 generate an endothermic effect or an exothermic effect.

The first memory deforming element 40 and the second memory deforming element 50 are disposed in a case 12, and the case 12 has a first end 121 and a second end 122. The first memory deforming element 40 and the second memory deforming element 50 are spiral-shaped. The first memory deforming element 40 has a connection part 41 and a movement part 42, and the second memory deforming element 50 has a connection part 51 and a movement part 52. The connection part 41 of the first memory deforming element 40 is disposed on the first surface 31, and the connection part 51 of the second memory deforming element 50 is disposed on the second surface 32. The movement part 42 of the first memory deforming element 40 is connected to the first end 121, and the connection part 52 of the second memory deforming element 50 is connected to the second end 122.

As shown in FIG. 3A, the movement part 42 of the first memory deforming element 40 is in an undeformed state, and the movement part 52 of the second memory deforming element 50 is in a deformed state. As shown in FIG. 3B, the movement part 42 of the first memory deforming element 40 is in the deformed state, and the movement part 52 of the second memory deforming element 50 is in the undeformed state.

When the control element 20 controls the current generated by the power source 11 to flow to the temperature chip 30 via the first path 21, the first surface 31 generates the endothermic effect, and the second surface 32 generates the exothermic effect, such that the first memory deforming element 40 is cooled and the second memory deforming element 50 is heated. Therefore, the movement part 42 of the first memory deforming element 40 is turned into the undeformed state, and the movement part 52 of the second memory deforming element 50 is turned into the deformed state, as shown in FIG. 3A. On the contrary, when the control element 20 controls the current generated by the power source 11 to flow to the temperature chip 30 via the second path 22, the movement part 42 of the first memory deforming element 40 is turned into the deformed state, and the movement part 52 of the second memory deforming element 50 is turned into the undeformed state, as shown in FIG. 3B. When the current direction is always switched, the movement device 10 performs a left-and-right moving motion repeatedly within the case 12. The second embodiment of the present invention may be applied to, for example, simulate a piston motion, or when an object (not shown) is installed on the temperature chip 30, the second embodiment of the present invention can be used to drive the object to move planarly left and right.

As shown in FIG. 3C, it shows an extension application of the second embodiment of the present invention, and the basic operation principle and the numerals are the same as that of the second embodiment, which thus are not described repeatedly here. In this application, when the control element 20 controls the current generated by the power source 11 to flow to different temperature chips 30 via any one of a first path 21, a second path 22, a third path 23, a fourth path 24, a fifth path 25, and a sixth path 26, a first memory deforming element 40, a second memory deforming element 50, a third memory deforming element 60, and a fourth memory deforming element 70 are deformed or not deformed, such that the movement device 10 produces more motion combinations.

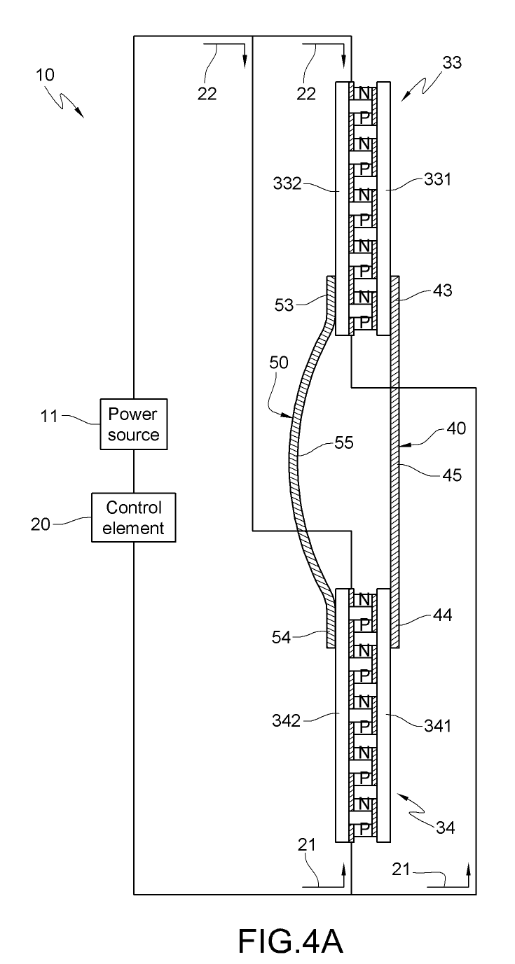

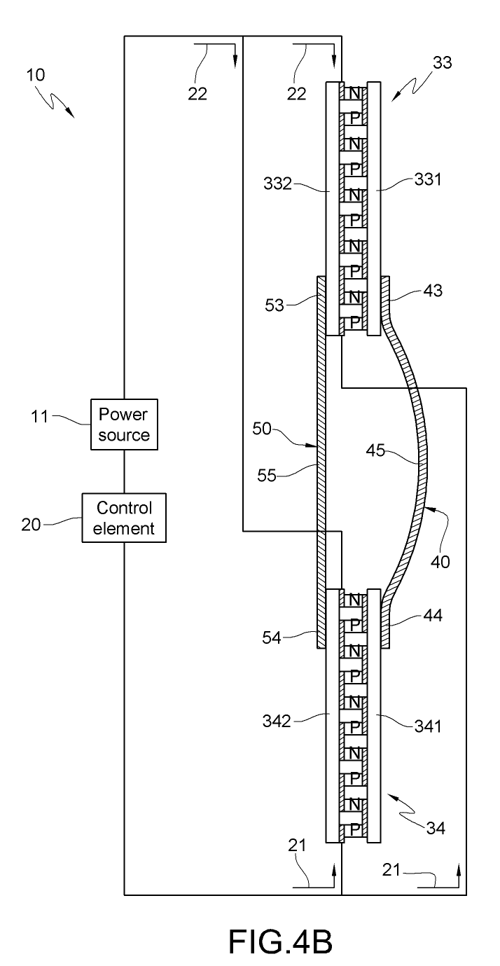

FIGS. 4A and 4B are schematic views of a third embodiment of the present invention. Referring to FIGS. 4A and 4B, a movement device 10 of the present invention performs a mechanical movement upon being powered by a power source 11. The movement device 10 includes a control element 20, a first temperature chip 33, a second temperature chip 34, a first memory deforming element 40, and a second memory deforming element 50.

The control element 20 is electrically connected to the power source 11, and the first temperature chip 33 and the second temperature chip 34 are electrically connected to the control element 20 respectively. The first temperature chip 33 has a first surface 331 and a second surface 332, and the second temperature chip 34 has a first surface 341 and a second surface 342. The power source 11 produces a DC. The control element 20 switches a current direction of the power source 11, and controls the current to flow to the first temperature chip 33 and the second temperature chip 34 via a first path 21 or a second path 22, such that the first surface 331 and the second surface 332 of the first temperature chip 33 and the first surface 341 and the second surface 342 of the second temperature chip 34 generate an endothermic effect or an exothermic effect.

The first memory deforming element 40 has a first connection part 43, a second connection part 44, and a movement part 45. The second memory deforming element 50 has a first connection part 53, a second connection part 54, and a movement part 55. The first connection part 43 of the first memory deforming element 40 is disposed on the first surface 331 of the first temperature chip 33, and the second connection part 44 is disposed on the first surface 341 of the second temperature chip 34. The first connection part 53 of the second memory deforming element 50 is disposed on the second surface 332 of the first temperature chip 33, and the second connection part 54 is disposed on the second surface 342 of the second temperature chip 34.

As shown in FIG. 4A, the movement part 45 of the first memory deforming element 40 is in an undeformed state, and the movement part 55 of the second memory deforming element 50 is in a deformed state. As shown in FIG. 4B, the movement part 45 of the first memory deforming element 40 is in the deformed state, and the movement part 55 of the second memory deforming element 50 is in the undeformed state.

When the control element 20 controls the current generated by the power source 11 to flow to the temperature chip 30 via the first path 21, the first surface 31 generates the endothermic effect, and the second surface 32 generates the exothermic effect, such that the first memory deforming element 40 is cooled and the second memory deforming element 50 is heated. Therefore, the movement part 45 of the first memory deforming element 40 is turned into the undeformed state, and the movement part 55 of the second memory deforming element 50 is turned into the deformed state, as shown in FIG. 4A. On the contrary, when the control element 20 controls the current generated by the power source 11 to flow to the temperature chip 30 via the second path 22, the movement part 45 of the first memory deforming element 40 is turned into the deformed state, and the movement part 55 of the second memory deforming element 50 is turned into the undeformed state, as shown in FIG. 4B. When the current direction is always switched, the movement device 10 performs a left-and-right bending movement in sequence. The third embodiment of the present invention may be applied to a facial expression motion of the robot, for example, sucking air into the mouth.

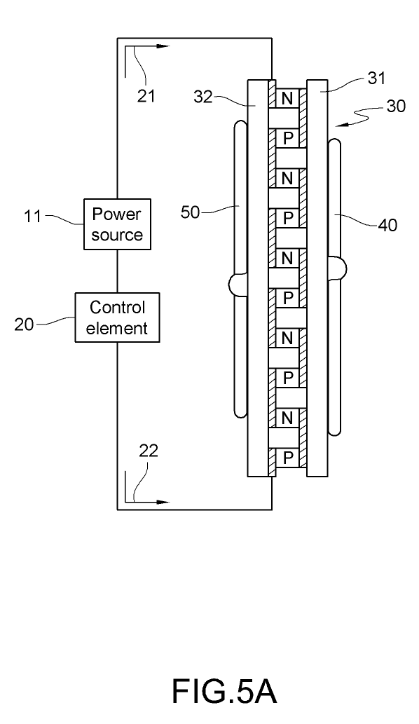

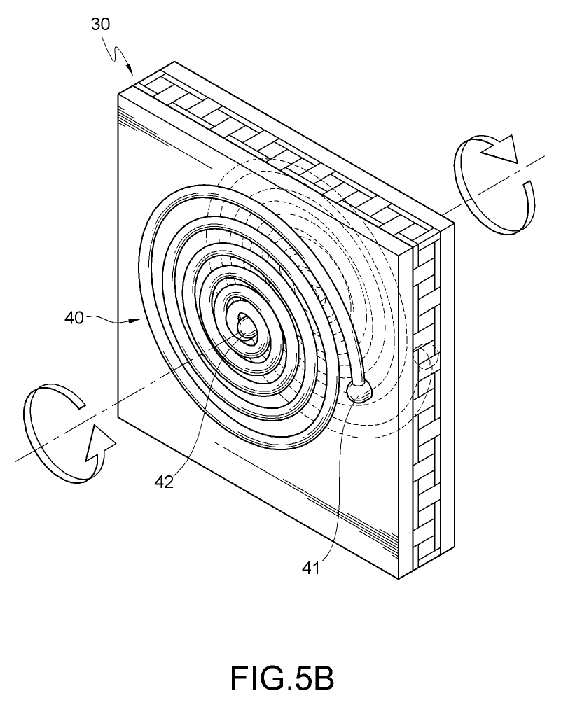

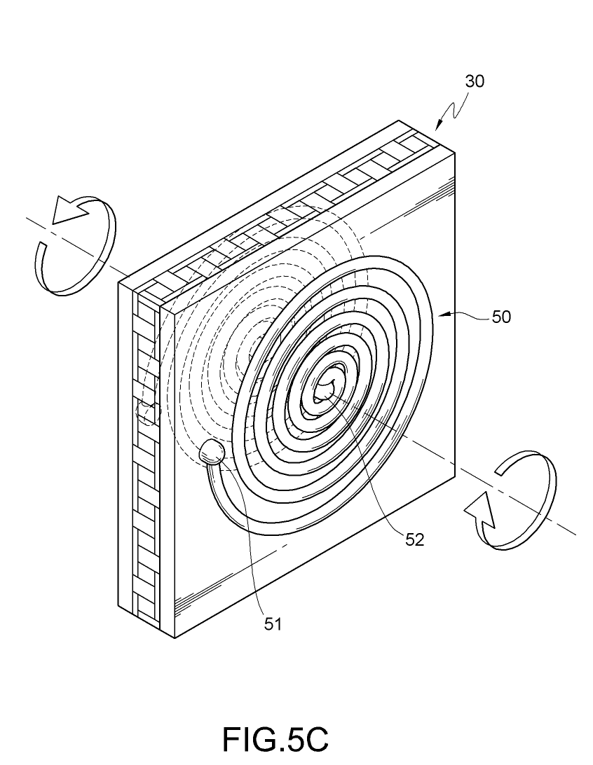

FIGS. 5A and 5C are schematic views of a fourth embodiment of the present invention. Referring to FIGS. 5A and 5C, a movement device 10 of the present invention performs a mechanical movement upon being powered by a power source 11. The movement device 10 includes a control element 20, a temperature chip 30, a first memory deforming element 40, and a second memory deforming element 50.

The control element 20 is electrically connected to the power source 11, and the temperature chip 30 is electrically connected to the control element 20. The temperature chip 30 has a first surface 31 and a second surface 32, and two ends of the temperature chip 30 are electrically connected to the power source 11 respectively. The power source 11 supplies a DC. The control element 20 switches a current direction of the power source 11, and controls the current to flow to the temperature chip 30 via a first path 21 or a second path 22, such that the first surface 31 and the second surface 32 generate an endothermic effect or an exothermic effect.

The first memory deforming element 40 and the second memory deforming element 50 are spiral-shaped. The first memory deforming element 40 has a connection part 41 and a movement part 42, and the second memory deforming element 50 has a connection part 51 and a movement part 52. The connection part 41 and the movement part 42 of the first memory deforming element 40 are disposed on the first surface 31, and the connection part 51 and the movement part 52 of the second memory deforming element 50 are disposed on the second surface 32.

As shown in FIGS. 5A to 5C, when the control element 20 controls the current generated by the power source 11 to flow to the temperature chip 30 via the first path 21, the first surface 31 generates the endothermic effect, and the second surface 32 generates the exothermic effect, such that the first memory deforming element 40 is cooled and the second memory deforming element 50 is heated. Therefore, the first memory deforming element 40 is turned into the undeformed state, and the second memory deforming element 50 is turned into the deformed state. On the contrary, when the control element 20 controls the current generated by the power source 11 to flow to the temperature chip 30 via the second path 22, the first memory deforming element 40 is turned into the deformed state, and the second memory deforming element 50 is turned into the undeformed state. When the current direction is always switched, the movement device 10 performs a rotating movement repeatedly. The fourth embodiment of the present invention may be applied to achieve the motion that, for example, the robot rotates a lower arm relative to an upper arm. The efficacies of the present invention are listed as follows. The control element controls the direction of the current when passing through the temperature chip, and the first surface and the second surface respectively generate the exothermic effect or the endothermic effect, so the first memory deforming element and the second memory deforming element are heated or cooled, and thus the movement part of the first memory deforming element and the movement part of the second memory deforming element are turned into the deformed state or the undeformed state respectively through the temperature control, so as to produce a movement. In this manner, even after a long time usage, the operation smoothness of the movement device can still be guaranteed, and it is ensured that no noise is produced during the operation.

What is claimed is:

1. A movement device, suitable for performing a mechanical movement upon being powered by a power source, comprising:
a control element, electrically connected to the power source, for controlling a current direction of the power source;
a temperature chip, electrically connected to the control element, and having a first surface and a second surface, wherein a current of the power source passes through the temperature chip, and the first surface and the second surface respectively generate an exothermic effect or an endothermic effect according to the current direction of the power source; and
a first memory deforming element and a second memory deforming element, having a connection part and a movement part respectively, wherein the connection part of the first memory deforming element and the connection part of the second memory deforming element are respectively disposed on the first surface and the second surface, the movement part of the first memory deforming element and the movement part of the second memory deforming element are connected to each other, the movement parts have a deformed state and an undeformed state, the first surface and the second surface respectively generate the exothermic effect or the endothermic effect, so the first memory deforming element and the second memory deforming element are heated or cooled, and thus the movement part of the first memory deforming element and the movement part of the second memory deforming element produce a swing movement through temperature control.

2. A movement device, suitable for performing a mechanical movement upon being powered by a power source, comprising:
a control element, electrically connected to the power source, for controlling a current direction of the power source;
a temperature chip, electrically connected to the control element, and having a first surface and a second surface, wherein a current of the power source passes through the temperature chip, and the first surface and the second surface respectively generate an exothermic effect or an endothermic effect according to the current direction of the power source; and
a first memory deforming element and a second memory deforming element, having a connection part and a movement part respectively, wherein the connection part of the first memory deforming element and the connection part of the second memory deforming element are respectively disposed on the first surface and the second surface, each movement parts have a deformed state and an undeformed state, the first surface and the second surface respectively generate the exothermic effect or the endothermic effect, so the first memory deforming element and the second memory deforming element are respectively heated or cooled in sequence, and thus the movement part of the first memory deforming element and the movement part of the second memory deforming element produce a reciprocating movement through temperature control.

3. The movement device according to claim 2, wherein the first memory deforming element and the second memory deforming element are spiral-shaped.

4. A movement device, suitable for performing a mechanical movement upon being powered by a power source, comprising:
a control element, electrically connected to the power source, for controlling a current direction of the power source;
a first temperature chip and a second temperature chip, electrically connected to the control element, and having a first surface and a second surface respectively, wherein a current of the power source passes through the first temperature chip and the second temperature chip, and the first surface and the second surface respectively generate an exothermic effect or an endothermic effect according to the current direction of the power source; and
a first memory deforming element and a second memory deforming element, having a first connection part, a second connection part, and a movement part respectively, wherein the first connection part of the first memory deforming element and the first connection part of the second memory deforming element are respectively disposed on the first surface and the second surface of the first temperature chip, the second connection part of the first memory deforming element and the second connection part of the second memory deforming element are respectively disposed on the first surface and the second surface of the second temperature chip, the movement part of the first memory deforming element and the movement part of the second memory deforming element have a deformed state and an undeformed state respectively, the first surface and the second surface respectively generate the exothermic effect or the endothermic effect, so the first memory deforming element and the second memory deforming element are respectively heated or cooled, and thus the movement part of the first memory deforming element and the movement part of the second memory deforming element sequentially produce a bending movement through temperature control.

5. A movement device, suitable for performing a mechanical movement upon being powered by a power source, comprising:
a control element, electrically connected to the power source, for controlling a current direction of the power source;
a temperature chip, electrically connected to the control element, and having a first surface and a second surface, wherein a current of the power source passes through the temperature chip, and the first surface and the second surface respectively generate an exothermic effect or an endothermic effect according to the current direction of the power source; and
a first memory deforming element and a second memory deforming element, having a connection part and a movement part respectively, wherein the connection part and the movement part of the first memory deforming element and the connection part and the movement part of the second memory deforming element are respectively disposed on the first surface and the second surface, each movement part has a deformed state and an undeformed state, the first surface and the second surface respectively generate the exothermic effect or the endothermic effect, so the first memory deforming element and the second memory deforming element are heated or cooled, such that the first memory deforming element and the second memory deforming element generate a rotating movement through temperature control.

6. The movement device according to claim 5, wherein the first memory deforming element and the second memory deforming element are spiral-shaped.
